(19) United States
(12) Patent Application Publication
(10) Pub. No.: US 2013/0211640 A1
(43) Pub. Date: Aug. 15, 2013

(54) PROPULSION DEVICE FOR AN ALL-WHEEL-DRIVE VEHICLE AND METHOD FOR DISTRIBUTING THE DRIVE TORQUE TO A FRONT AXLE DRIVE AND A REAR AXLE DRIVE

(71) Applicants: Ruben Maier, Eching Dietersheim (DE); Harald Brunner, Greding (DE); Alexander Kruse, Ingolstadt (DE)

(72) Inventors: Ruben Maier, Eching Dietersheim (DE); Harald Brunner, Greding (DE); Alexander Kruse, Ingolstadt (DE)

(73) Assignee: Audi AG, Ingolstadt (DE)

(21) Appl. No.: 13/642,069

(22) PCT Filed: Apr. 15, 2011
(86) PCT No.: PCT/EP11/01918

§ 371 Date: Dec. 13, 2012

(30) Foreign Application Priority Data
Apr. 19, 2010 (DE) 10 2010 015 423.7

(51) Int. Cl. B60W 20/00; B60W 10/08; B60W 10/06

(52) U.S. Cl. CPC B60W 20/108; B60W 10/06; B60W 10/08; B60W 2600/00; Y10S 903/93
USPC 701/22; 180/65.265; 903/930

(57) ABSTRACT

The invention relates to a propulsion device for an all-wheel-drive vehicle with a front-axle drive (5, 7) and a rear-axle drive (19; 33, 34), which propulsion device has an electronic control device which defines a drive torque (M_{Summe}) for driving the vehicle based on a driver request. The electronic control device is associated with a torque distribution unit (25), by way of which the drive torque (M_{Summe}) can be variably distributed to the front-axle drive (5, 7) and the rear-axle drive (19; 33, 34) as a function of input parameters generated by a driver-assistance controller (31).

The invention relates to a propulsion device for an all-wheel-drive vehicle according to the preamble of claim 1 and a method for operating such propulsion device according to claim 11.

Among the hybrid propulsion systems for vehicles, a variant referred to as through-the-road hybrid is known, wherein a vehicle axle is driven by a conventional internal combustion engine and the other vehicle axle is driven by an electric machine. Alternatively, the front and/or rear axle of the vehicle can also be driven by a hybrid module composed of an internal combustion engine and an electric machine, or by several electric machines. The all-wheel control depends here on the road conditions.

In an all-wheel-drive mode of such a hybrid vehicle, the internal combustion engine is operated at a predetermined power. In addition, the electric machine also supplies a torque via the electric axle to increase the overall output torque. The electrical energy is hereby supplied by the battery.

DE 10 2005 026 874 A1 discloses a generic propulsion device for such an all-wheel-drive vehicle, which has on the front axle an internal combustion engine driving the two front vehicle wheels via a gear. Two electric machines which are mechanically decoupled therefrom are provided on the rear axle. The two electric machines can be drivingly connected to each other and to the rear vehicle wheels via clutches or can be uncoupled from each other. This device can be used to effectively control and/or support especially the cornering ability and the maneuverability of the vehicle. The electric drive device also provides an intelligent all-wheel-drive which can operate without requiring a relatively complex mechanical transmission via propeller shaft and a rear differential, thereby enabling a very effective torque vectoring with two relatively small electric motors and an electric machine with clutches disposed on the rear axle.

For implementing an all-wheel-drive mode, the internal combustion engine arranged on the front axle supplies a drive torque. Simultaneously, the two electric machines arranged on the rear axle also supply a driving torque. In the all-wheel-drive mode, the two electric machines thus derive electrical power entirely from the traction battery. The all-wheel-drive mode thus strongly depends on the available battery power of the traction battery.

It is an object of the invention to provide a propulsion device for an all-wheel-drive vehicle and a method for operating such propulsion device, which ensures a permanent all-wheel-drive mode compared to the state of the art.

The object is attained with the features of claim 1 or claim 11. Advantageous embodiments of the invention are recited in the dependent claims.

According to the characterizing part of claim 1, the electronic control device, which determines in response to a request from the driver a drive torque, includes a torque distribution unit with which the drive torque can be variably distributed to the front axle and the rear axle depending on input parameters generated in a driver assistance controller. In contrast to the present invention, the drive shaft to the vehicle wheels in a mechanical all-wheel-drive is implemented mechanically, whereby the torque distribution from the front axle to the rear axle, and vice versa, can be varied only within the limits defined by the mechanical components.

Exemplary input parameters for the torque distribution unit are, for example, the available battery power, characteristic efficiency curve fields of all power units, propulsion unit temperature/ambient temperature, driving dynamics limits, load points of the propulsion units and the vehicle speed, the engaged gear as well as the transmission efficiency.

In response to a torque input step inputted with a pedal module in response to a driver command, the drive torque can thus be distributed to the front axle and the rear axle depending on these input parameters.

The calculated torque can be variably distributed to the front and rear axles depending on the selected driving mode (for example, hybrid, sports or electric driving mode). The electronic control device can then define an efficiency mode when detecting low vehicle speeds, wherein the entire torque is transmitted to the exclusively electrically operated vehicle axle. In this situation, the gear in the speed change gear of the engine is disengaged, and only the rear axle is driven to save energy. Such low speeds can result in city driving at vehicle speeds in the range of 50 km/h. Conversely, when lateral dynamic situations are present, the electronic control device may control the propulsion device in an all-wheel-drive mode.

In addition, the electronic control device may distribute the drive torque to the front axle drive and the rear axle drive depending on the available traction battery power. The torque distribution must generally be performed within the driving dynamics limits to ensure the highest level of safety.

It is particularly advantageous when the front axle drive and the rear axle drive are mechanically decoupled from each other, without using a relatively complex mechanical transmission via propeller shaft and differentials. The front axle and the rear axle are then not driven by a common drive train, but independent of each other by the two abovementioned axle drives.

In one embodiment of the invention, the propulsion system on the vehicle front axle may drive the two front wheels of the vehicle not only with an internal combustion engine, but in addition also with an electric machine. The rear axle may have at least one electric machine arranged on the vehicle rear axle and configured to drive the two rear wheels of the vehicle. In this way, in all-wheel-drive mode, the electric machine associated with the front axle can generate electric power that can be provided to the electric machine associated with the rear axle, without loading the traction battery.

In this way, the electric machine provided on the rear axle can be supplied with electrical power in all-wheel-drive mode not only from the traction battery, but in addition also from the electric machine arranged on the front axle.

Alternatively to the aforementioned embodiment, the invention includes, of course, also a propulsion system, wherein the internal combustion engine is not arranged on the front axle, but instead on the rear axle. In this case, the electric machine arranged on the rear axle can generate electric power in all-wheel-drive mode, which can then be provided to the electric machine arranged on the front axle. In all-wheel-drive mode, the driving torques are therefore transmitted to the vehicle wheels from both the internal combustion engine of the front axle/rear axle drive and from the electric machine of the other axle drive.

The electric machine, which together with the internal combustion engine forms an axle drive, is used in the aforedescribed all-wheel-drive mode to generate electric power. The generated electric power can be consumed by the electric machine arranged on the other vehicle axle. For this purpose, the electric machine operating in recuperation mode is connected via supply lines to the electric machine used as motor directly and/or through interposition of a traction battery. The electric power can thus be transmitted directly to the electric machine operating as a motor. Alternatively, the generated electric power may also be temporarily stored in the traction battery.

Two exemplary embodiments of the invention will now be described with reference to the appended figures, which show in:

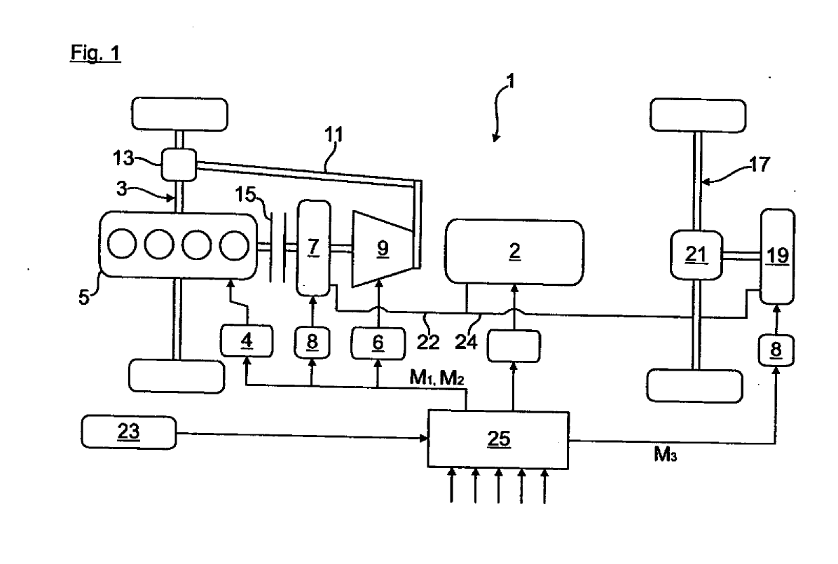

FIG. 1 in a schematic view, a propulsion system of a motor vehicle according to the first exemplary embodiment;

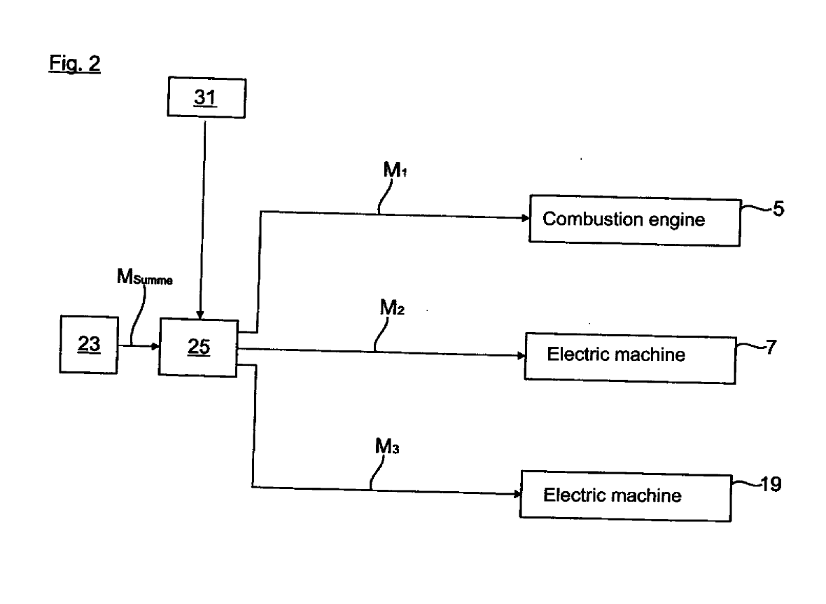

FIG. 2 a block circuit diagram schematically illustrating the signal flow to the front axle drive and to the rear axle drive, starting from a driver-side torque;

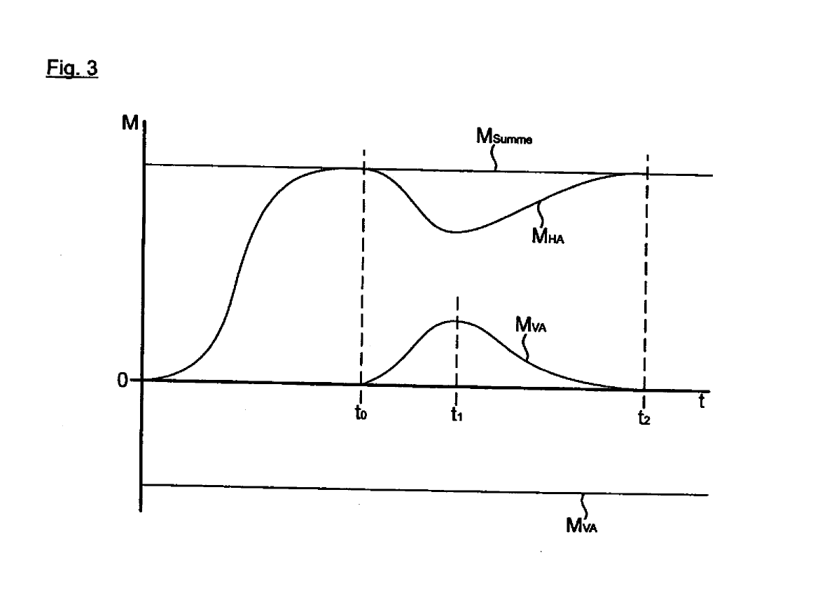

FIG. 3 a torque-time diagram, illustrating a start mode with ASR intervention; and

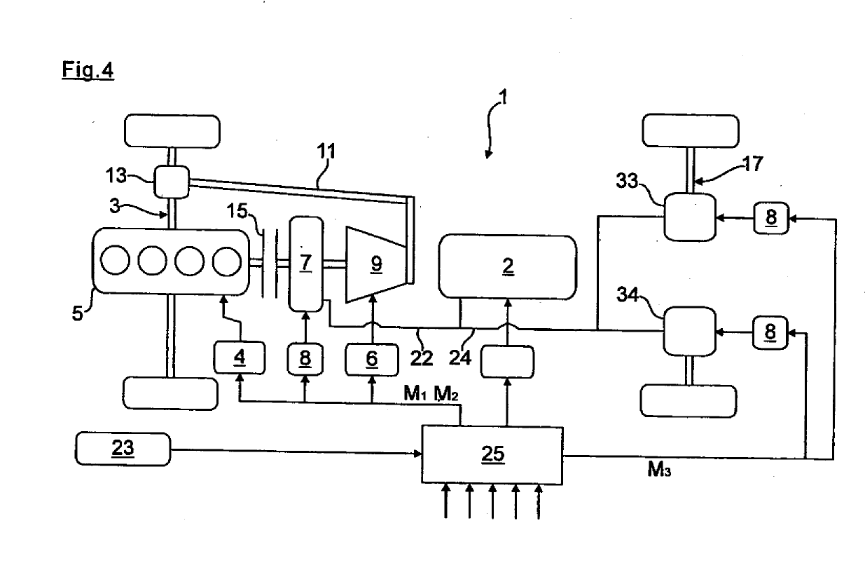

FIG. 4 in a view corresponding of FIG. 1, a propulsion system of a motor vehicle according to the second exemplary embodiment.

FIG. 1 shows in a schematic diagram the propulsion system of a hybrid vehicle which has an all-wheel-propulsion unit 1. An internal combustion engine 5 and an electric machine 7 are connected in a drive train on the front axle of the vehicle 3 and connected with a gear 9. The gear 9 is drivingly connected with the front axle 3 via a transmission output shaft 11 and a schematically indicated axle differential 13. A clutch 15 is connected between the internal combustion engine 5 and the electric machine 7, which is disengaged or engaged depending on the driving situation.

An additional electric machine 19, which drives the two rear wheels of the vehicle via an axle differential 21, is arranged on the rear axle 17 of the motor vehicle.

The front-axle drive composed of the internal combustion engine 5 and the electric machine 7 and the rear axle drive composed of the electric machine 19 are schematically indicated only insofar as it is necessary for an understanding of the invention. Other drive components, such as the high-voltage battery 2 supplying power to the two electric machines 7, 19, or the engine control unit 4, the transmission control unit 6 or the power electronics 8 of the two electric machines 7, 19 are indicated only coarsely without further description for sake of clarity.

As seen from the FIG. 1, the electric machine 7 of the front axle drive is directly connected with the high-voltage battery 2 via a supply line 22. Additionally, the electric machine 11 is connected directly to the electric machine 19 of the rear axle drive via a branch line 24 that branches off from the supply line 22.

A central electronic control device 25 is provided for controlling the drive units 5, 7, 19 of the all-wheel-drive vehicle. The control device 25 measures as an input parameter, among others, the available battery power, the efficiency characteristic curve fields of all drive units 5, 7, 19, ambient temperature and/or propulsion unit temperature, driving dynamics limits, load points of the propulsion units 5, 7, 19 and the vehicle speed, the engaged gear and also the transmission efficiency, thereby enabling an axle-specific torque distribution.

In addition, a desired torque requested by a driver is transmitted from the pedal module 23 to the control device 25. Based on these input parameters, the control device 25 calculates the target torques M₁ to M₃, with which the internal combustion engine 5, the electric machine 7, and the electric machine 19 can be controlled accordingly.

A highly simplified signal flow between the pedal module 23 and the front axle 5, 7 and the rear axle 19 is shown in FIG. 2. Accordingly, a desired torque requested by the driver is supplied to the control device 25 from the pedal module 23 as a set point. This refers to a torque, a power level or a quantity derived from the torque or the power. In the present situation, the set point corresponds to a sum torque M_{Summe}. The control device 25 divides the sum torque M_{Summe} into the desired torques M₁ and M₂ for the front axle drive 5, 7 and a desired torque M₃ for the rear axle drive 19, as a function of generally known input parameters. The sum torque M_{Summe} is divided according to FIG. 2 by taking into account a driver assistance control 31.

The desired torques M₁, M₂ and M₃ are filtered in the control device 25, for example, in a low-pass filter and/or in a load impact damping filter 37, whereafter the desired torques are transmitted, after suitable processing, to the front axle drive 5, 7 and to the rear axle drive 19.

In order to ensure a permanent all-wheel-drive mode even with diminished available battery power, the control device 25 may control the drive torque destined for the front axle 5, 7 so that only the internal combustion engine 5 supplies a desired torque M₁, whereas the electric machine 7 is not controlled with a desired torque. The electric machine 7 of the front axle drive can recuperate in this operating mode, i.e., generate electric power. The generated electric power can be transmitted even in all-wheel-drive mode to the electric machine 17 which is arranged on the rear axle 19 and driven with a predetermined driving torque M₃. The all-wheel-drive mode is thus maintained without loading the traction battery 2.

Depending on the efficiency of the rear axle drive and/or the state of the battery, the electric power generated by the electric machine 7 can also be temporarily stored in the traction battery 2. In this way, in all-wheel-drive mode, the electric machine 19 arranged on the rear axle 17 can be supplied from both the traction battery 2 and the electric machine 7 arranged on the front axle 3 as energy source.

A driving situation will now be described with reference to the torque-time diagram of FIG. 3, wherein only the rear axle 19 is initially controlled with the setpoint M_{HA} until the time t₀. The setpoint M_{HA} therefore corresponds to the sum torque M_{Summe}. A driving situation represented by this type of efficiency may arise, for example, in a startup mode on a mountain.

Slip of the rear axle 17 is detected by the driver assistance control 31 after the time t₀. In response, an ASR intervention takes place wherein the torque distribution unit 25 redistributes the drive torque to the front axle 3 depending on input parameters from the driver assistance control 31.

The determined slip then decreases again from the time t₁, so that the desired torque M_{HA} destined for the rear axle 17 increases again commensurately. The ASR intervention is completed at time t₂. In other words, there is no longer slip on the rear axle 17 and the vehicle is driven solely via the rear axle 17.

FIG. 4 shows a propulsion system according to the second exemplary embodiment, which has in principle a similar structure as and operates similar to the first exemplary embodiment. In contrast to FIG. 1, electric machines 33, 34 are arranged on the rear axle 2, with the first electric machine 33 driving the drive wheel located on the right side of the vehicle and the second electric machine 34 driving the drive wheel arranged on the left side of the vehicle.

As further shown in FIG. 4, the two rear electric machines 33, 34 can be controlled with desired torques M₃ and M₄. The two rear electric machines 33, 34 can be controlled via dynamic torque distribution, wherein the predetermined desired torques M₃ and M₄ can be dynamically adjusted depending on driving situations, for example, to improve cornering ability of the vehicle when driving through curves. For this purpose, an additional chassis control with associated driving dynamics sensors, such as yaw rate sensors, acceleration sensors, speed sensors, and RPM sensors may be provided in the vehicle, based on which this dynamic torque distribution can occur in the control device 25.

What is claimed is:

1.-12. (canceled)

13. A method for operating a propulsion device for an all-wheel-drive vehicle having a front axle drive with an internal combustion engine and a first electric machine and a rear axle drive with at least one second electric machine, with the rear axle drive being mechanically decoupled from the front axle drive, comprising the steps of:
determining with an electronic control device an overall drive torque for driving the vehicle in response to a request from a driver;
variably distributing with a torque distribution unit operatively connected with the electronic control device the overall drive torque to the front axle drive and the rear axle drive commensurate with input parameters generated in a driver assistance system,
at low vehicle speeds in city driving in a range of 50 km/h, controlling with the torque distribution unit so as to supply the overall drive torque only to the rear axle drive, and
in presence of lateral dynamic effects, controlling the propulsion device with the electronic control device in an all-wheel-drive mode,
wherein the overall drive torque is always distributed within driving dynamics limits.

14. The method of claim 13, wherein the torque distribution unit distributes the overall drive torque to the front axle drive and to the rear axle drive commensurate with electric power available from a traction battery.

15. The method of claim 13, wherein for all-wheel operation, the internal combustion engine of the front axle drive drives the first vehicle axle, wherein electric power is generated by the first electric machine and provided to the at least one second electric machine.

16. The method of claim 15, wherein in all-wheel-drive mode, the electric power generated by the first electric machine and the electric power from a traction battery are supplied to the at least one second electric machine.

17. The method of claim 15, wherein the electric power generated by the first electric machine is supplied to the second electric machine via a supply line directly or by interconnecting a traction battery.

18. The method of claim 13, wherein at least one of the front axle drive and the rear axle drive comprises two electric machines.
